(19) United States
(12) Patent Application Publication
(10) Pub. No.: US 2025/0301088 A1
(43) Pub. Date: Sep. 25, 2025

(54) INFORMATION PROCESSING SYSTEM, NON-TRANSITORY COMPUTER READABLE MEDIUM, AND INFORMATION PROCESSING METHOD

(71) Applicant: FUJIFILM Business Innovation Corp., Tokyo (JP)

(72) Inventor: Kenji NOMURA, Kanagawa (JP)

(73) Assignee: FUJIFILM Business Innovation Corp., Tokyo (JP)

(21) Appl. No.: 18/775,190

(22) Filed: Jul. 17, 2024

(30) Foreign Application Priority Data
Mar. 22, 2024 (JP) 2024-045838

(51) Int. Cl. H04N 1/32; G06V 30/412

(52) U.S. Cl. CPC H04N 1/3247; G06V 30/412; H04N 1/32464

(57) ABSTRACT

An information processing system includes a processor configured to: acquire document image data in a first format and document image data in a second format different from the first format, generated from a document including a plurality of pages; when the document image data in the first format includes reusable image data of the page of the document to regenerate the document image data in the second format in response to a change in a layout of the page of the document; extract the reusable image data of the page from the document image data in the first format; and regenerate the document image data in the second format by using the extracted image data of the page.

### CROSS-REFERENCE TO RELATED APPLICATIONS

This application is based on and claims priority under 35 USC 119 from Japanese Patent Application No. 2024-045838 filed Mar. 22, 2024.

### BACKGROUND

### (i) Technical Field

The present disclosure relates to an information processing system, a non-transitory computer readable medium, and an information processing method.

### (ii) Related Art

For example, the conversion of a document including a plurality of pages into image data by reading the document by using a scanner mounted on a multifunction peripheral has been performed in the related art. When the page layout of the document is changed, for example, a part of the pages of the document is replaced, it is possible to regenerate the image data of the document by reading all the pages forming the document after the change, but it takes time to regenerate the image data from the beginning in such a method.

Therefore, in the related art, a technique has been proposed which enables a change in page units such as replacement of a page with respect to the generated document image data (for example, Japanese Unexamined Patent Application Publication No. 2004-078761, Japanese Unexamined Patent Application Publication No. 2007-087043, and Japanese Unexamined Patent Application Publication No. 2007-043375).

### SUMMARY

When the document image data is regenerated in response to a change in the page layout of the document after the document image data is generated from the document including a plurality of pages, an unchanged page may also be additionally needed in addition to a page to be changed. For example, in what is generally called N-up printing, a plurality of pieces of page data is included in the image data corresponding to one print sheet. In this case, the image data corresponding to one print sheet is generated by combining the page to be changed and the page that has not been changed, but in the related art, the page of the document that has not been changed needs to be read again.

Furthermore, there is a case where a plurality of pieces of document image data in different formats is generated from the same document, but in this case, when another piece of document image data generated from the same document can be reused for regeneration of one piece of document image data, reuse is efficient.

Aspects of non-limiting embodiments of the present disclosure relate to, when one piece of document image data is regenerated in response to a change in the page layout of the document after a plurality of pieces of document image data in different formats is generated by reading the document including a plurality of pages, reducing the number of times the pages are read again, as compared with a case where the other pieces of document image data are not reused.

Aspects of certain non-limiting embodiments of the present disclosure overcome the above disadvantages and/or other disadvantages not described above. However, aspects of the non-limiting embodiments are not required to overcome the disadvantages described above, and aspects of the non-limiting embodiments of the present disclosure may not overcome any of the disadvantages described above.

According to an aspect of the present disclosure, there is provided an information processing system including a processor configured to: acquire document image data in a first format and document image data in a second format different from the first format, generated from a document including a plurality of pages; when the document image data in the first format includes reusable image data of the page of the document to regenerate the document image data in the second format in response to a change in a layout of the page of the document, extract the reusable image data of the page from the document image data in the first format; and regenerate the document image data in the second format by using the extracted image data of the page.

### BRIEF DESCRIPTION OF THE DRAWINGS

Exemplary embodiments of the present disclosure will be described in detail based on the following figures, wherein:

FIG. 1 is a block configuration diagram illustrating a hardware configuration of a multifunction peripheral according to the present exemplary embodiment;

FIG. 2 is a conceptual diagram illustrating multitask processing executed according to the present exemplary embodiment;

FIG. 3 is a flowchart illustrating print processing executed by a task B according to the present exemplary embodiment;

FIG. 4 is a diagram illustrating a block configuration of a function performed by executing the task B when a part of pages of a document is replaced according to the present exemplary embodiment;

FIG. 5 is a conceptual diagram illustrating another example of print processing executed by the task B when a part of pages of a document is replaced according to the present exemplary embodiment;

FIG. 6 is a diagram illustrating a block configuration of a function performed by executing the task B when a page is added to a document according to the present exemplary embodiment; and

FIG. 7 is a diagram illustrating a block configuration of a function performed by executing the task B when a page is deleted from a document according to the present exemplary embodiment.

### DETAILED DESCRIPTION

Hereinafter, a preferred exemplary embodiment of the disclosure will be described with reference to the drawings.

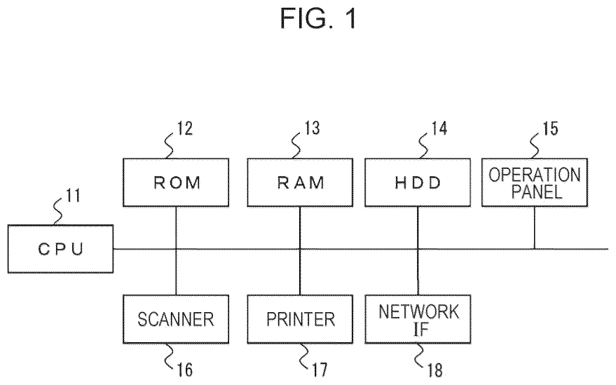

FIG. 1 is a block configuration diagram illustrating a hardware configuration of a multifunction peripheral 10 according to the present exemplary embodiment. The multifunction peripheral 10 according to the present exemplary embodiment is one form of an image forming apparatus and is an apparatus that is equipped with various functions such as a printing function, a copying function, and a scanner function and has a built-in computer. The multifunction peripheral 10 according to the present exemplary embodiment can be implemented with the same hardware configuration as before. For example, as illustrated in FIG. 1, the multifunction peripheral 10 includes a CPU 11, a ROM 12, a RAM 13, a hard disk drive (HDD) 14, an operation panel 15, a scanner 16, a printer 17, and a network interface (IF) 18. The ROM 12 stores various programs related to control of the apparatus, encryption of electronic date, and transmission and reception of electronic date, and the CPU 11 controls operation of various mechanisms mounted on the apparatus, such as the scanner 16 and the printer 17, in accordance with the programs stored in the ROM 12. The RAM 13 is used as a work memory at the time of program execution and a communication buffer at the time of electronic data transmission and reception. The HDD 14 stores image data, and the like, read by using the scanner 16. The operation panel 15 is a user interface that receives an instruction from a user and displays information. The scanner 16 reads a document that is set on a document table by a user and accumulates the read image as image data in the HDD 14, or the like. The printer 17 prints an image on a sheet in response to an instruction from a control program executed in the CPU 11. The network interface 18 is connected to a network and is used for transmission and reception of electronic data to and from an external apparatus, access to the apparatus via a browser, and the like.

In addition, the multifunction peripheral 10 according to the present exemplary embodiment includes an N-up function in the equipped printing function. The “N-up function” is a function that can lay out and print a plurality of pages of a document on a single sheet. Printing performed using the N-up function is referred to as “N-up printing”.

Furthermore, the multifunction peripheral 10 according to the present exemplary embodiment can perform multitask processing. That is, it has a function of executing an application which performs processing in a multitasking manner. This function is implemented by cooperative operation of a computer incorporated in the multifunction peripheral 10 and a program running on the CPU 11 installed in the computer. In addition, a program (multitask including a task A and a task B described below) used in the present exemplary embodiment can be provided not only by a communication unit but also by being stored in a computer-readable recording medium such as a USB memory. The programs provided from the communication unit or the recording medium are installed in the computer, and the CPU 11 of the computer sequentially executes the programs and thus implements various kinds of processing.

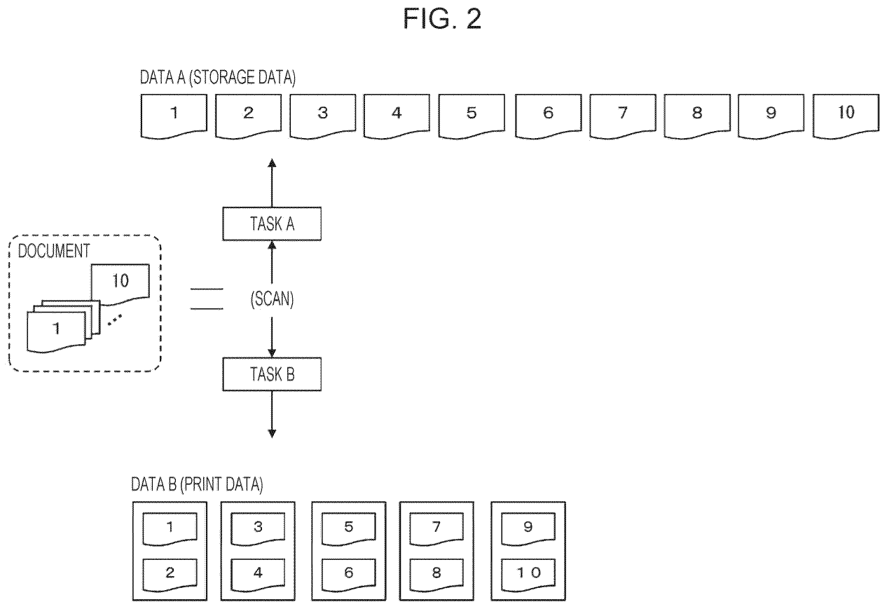

As described above, the multitask processing is executed in the multifunction peripheral 10 according to the present exemplary embodiment, and an example of the multitask processing will be described with reference to FIG. 2.

In the multifunction peripheral 10 according to the present exemplary embodiment, the task A and the task B included in the multitask are executed concurrently. Both the task A and the task B generate document image data in a predetermined format from the scan data generated when the scanner 16 reads a document including a plurality of pages set on the document table of the multifunction peripheral 10.

The task A generates storage data (hereinafter also referred to as “data A”) as document image data in a first format from the scan data. The document image data in the first format is, for example, TiFF data or PDF data. According to the present exemplary embodiment, it is not necessary to particularly limit the first format unless otherwise described. However, as illustrated in FIG. 2, the image data corresponding to one page included in the document image data in the first format is generated corresponding to each page forming the document. The image data corresponding to one page forming the document image data is referred to as “page data”.

The task B generates, from the scan data, print data (hereinafter also referred to as “data B”) as document image data in a second format different from the first format. The document image data in the second format is, for example, bitmap data. The task B according to the present exemplary embodiment generates the document image data in the second format as the document image data for performing N-up printing, for example, as illustrated in FIG. 2. That is, the image data corresponding to one page of a sheet included in the document image data in the second format is generated by laying out a plurality of pages forming the document. According to the present exemplary embodiment, the case where 2-up printing is performed will be described as an example, but it is not necessarily limited to 2-up. In the case of the task B, the image data corresponding to one page of a sheet is generated to include two pages of the document forming the document image data, and the image data corresponding to one page of a sheet including two pieces of page data will be referred to as “print page data” unlike the image data (i.e., page data) corresponding to one page of the document.

Although the case where the document illustrated in FIG. 2 includes 10 pages as a plurality of pages is exemplified, this number of pages is merely an example and need not be limited thereto. Furthermore, the task A does not necessarily need to generate the document image data for storage and may generate the document image data for any other purposes. Similarly, the task B may generate the document image data for purposes other than printing.

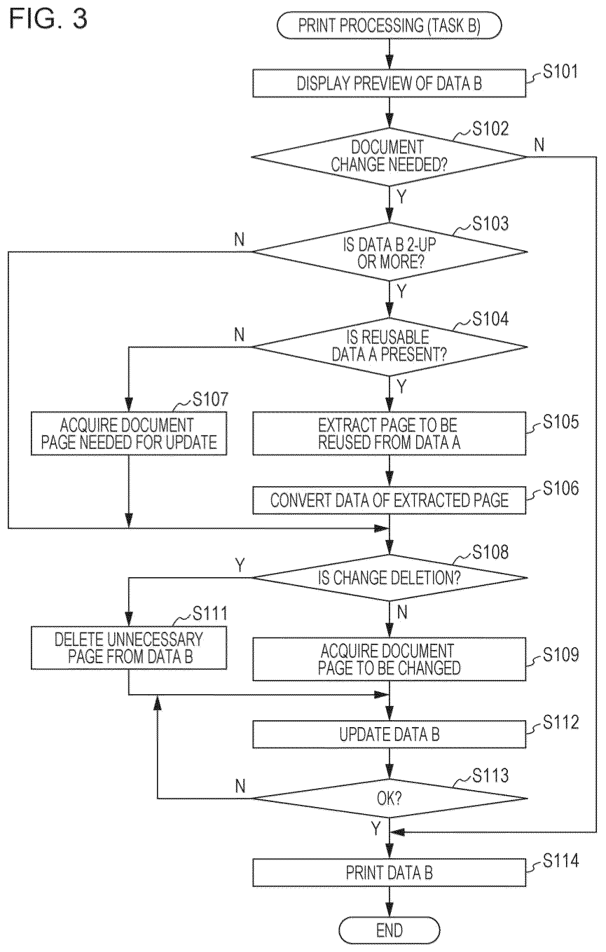

Next, an operation according to the present exemplary embodiment will be described. According to the present exemplary embodiment, since the processing content in the task B is mainly characteristic, the description will be given with reference to the flowchart illustrated in FIG. 3, focusing on the print processing executed by the task B.

The user of the multifunction peripheral 10 sets a document on the document table and selects and executes multitask processing from a menu displayed on the operation panel 15. Thus, as illustrated in FIG. 2, data A and data B are generated from the scan data of the document. The user displays the generated preview image of the data B on the operation panel 15 and confirms the contents of the data B (Step S101).

Here, when there is no problem with the data B and document change is not needed (N in Step S102), a printing instruction for the data B is given by performing a predetermined operation. The task B prints the data B in response to an instruction from the user (Step S114).

Conversely, when document change is needed (Y in Step S102), an operation for a change is performed.

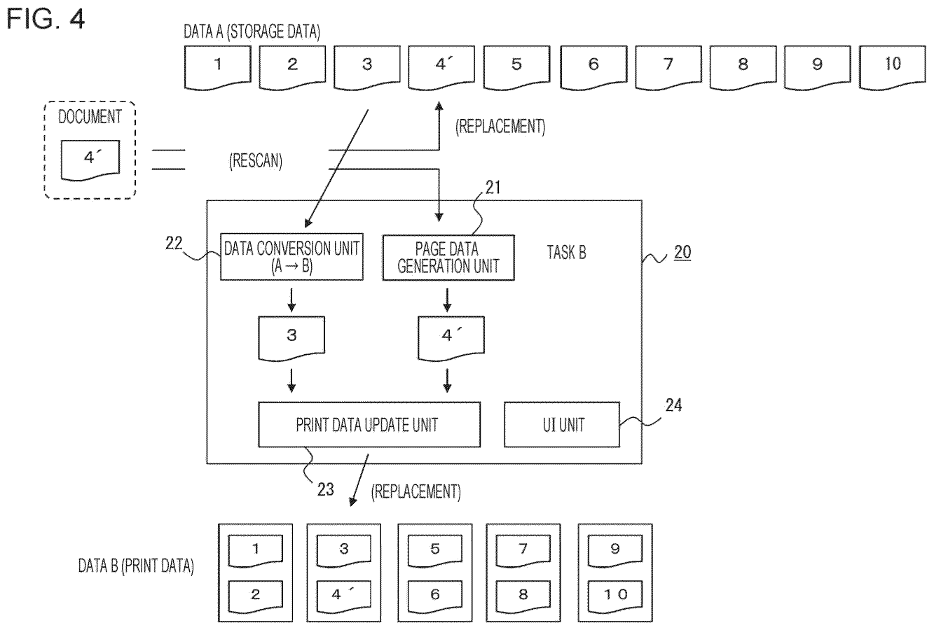

Furthermore, the case of changing the page layout of the document includes replacement of a page, addition of a page, or deletion of a page that forms the document. Hereinafter, the case of changing these pages will be described individually. First, the case of replacing the page forming the document will be described with reference to FIG. 4.

FIG. 4 is a diagram illustrating a block configuration of a function performed by executing the task B when a part of pages of a document is replaced according to the present exemplary embodiment. The task B includes, as functions, a page data generation unit 21, a data conversion unit 22, a print data update unit 23, and a user interface (UI) unit 24. FIG. 4 illustrates only constituent elements needed for page replacement.

The page data generation unit 21 generates image data in the second format from the scan data of the page of the document to be replaced. The present exemplary embodiment is characterized by that, when the page data included in the data A is reusable, the page data is reused as described below; however, the page data in the first format cannot be reused as it is. Therefore, the data conversion unit 22 acquires the data A and converts the page data in the first format extracted for reuse from the data A into the page data in the second format. The print data update unit 23 acquires the page data from the page data generation unit 21 and the data conversion unit 22 and generates the print page data to be replaced, thereby regenerating, that is, updating the document image data. The user interface unit 24 receives a user operation input from the operation panel 15 and displays a preview image of the updated document image data on the operation panel 15.

Here, the case where the fourth page of the document is replaced will be described as an example.

Referring to the print data illustrated in FIG. 4, the fourth page of the document is to be combined with the third page. Therefore, the page data of the third page is needed to generate the print page data of the second page in the print data formed by the third and fourth pages of the document. The task B according to the present exemplary embodiment is characterized in that the page data of the third page is acquired not by rescanning the third page of the document but by being extracted from the task A. Thus, when the data A includes reusable page data (Y in Step S104), the task B extracts and acquires the reusable page data from the data A (Step S105). However, since the page data extracted from the task A is in the first format, the data conversion unit 22 converts the page data of the third page acquired from the task A into page data in the second format (Step S106). When the data A does not include reusable page data (N in Step S104), since there is no choice but to rescan and acquire the third page of the document, the task B causes the user to scan and acquire the third page of the document, for example, by displaying a message for scanning the third page of the document on the operation panel 15 (Step S107). In this way, the task B acquires the page data (i.e., the page data of the third page) of the document that is needed to update the print page data.

Furthermore, since the fourth page of the document is to be replaced, the user scans the page to be replaced (illustrated as “4” in FIG. 4) by operating the operation panel 15. When acquiring the scan data of the fourth page by scanning, the page data generation unit 21 generates the page data of the fourth page in the second format from the scan data (N in Step S108, S109).

Further, the flowchart illustrates the flow of processing for separately acquiring the third and fourth pages forming the print page data (Step S107, S109) for convenience of explanation, but the flow of processing may be such that the case where the user collectively scans the third and fourth pages of the document is assumed.

As described above, when the page data (hereinafter also referred to as “replacement page data”) of the fourth page to be replaced and the page data of the third page that is included in the same print page data as the replacement page data and is extracted from the data A and converted into the second format are acquired, the print data update unit 23 generates the print page data of the second page in the data B to include these pieces of page data. Further, the print data update unit 23 acquires the data B and updates the print data (i.e., the data B) by replacing the second page in the acquired data B with the generated print page data (Step S112).

The user interface unit 24 causes the user to confirm the regenerated data B by displaying the regenerated data B on the operation panel 15. The user checks whether the orientation and the arrangement order of the page data included in the print page data are correct in the regenerated data B. When the orientation and the arrangement order of the page data in the data B are not correct (N in Step S113), the user corrects the orientation and the arrangement order by performing a predetermined user operation such as drag & drop on the operation panel 15. The print data update unit 23 updates the data B in response to the user operation (Step S112). Next, upon confirmation and a predetermined print instruction operation by the user (Y in Step S113), the task B prints the data B (Step S114).

As described above, according to the present exemplary embodiment, when the image data of the unchanged document page is needed to generate the print page data to be replaced, the document image data in another format generated from the same document is reused without rescanning the unchanged document so that the number of times the page of the document are read again can be reduced.

As described above, according to the present exemplary embodiment, the data A in the first format is reused when the data B in the second format is regenerated. In order to reuse the data A, it is assumed that the first format of the data A is a format that can be converted into the second format of the data B.

Although the first format and the second format are different formats, the data formats do not necessarily need to be different from each other. That is, the term “different formats” includes not only the case where the data formats of images are different from each other, such as TIFF and bitmap, but also the case where the page data corresponding to one page of the document is included in the print page data forming the print data and the case where the page data corresponding to a plurality of pages of the document is included, such as N-up, even when the data have the same data format. When the first format and the second format are the same data format, the data conversion by the data conversion unit 22 is not necessary.

Further, according to the present exemplary embodiment, the task A and the task B are included in the same multitask so that they are associated with a task that uses the scan data of the same document and are mutually reusable. However, as long as the task A and the task B are associated with each other in that they use the data derived from the same document, they do not necessarily need to be in a relationship of forming a multitask. For example, when the data A and the data B are associated with each other in that they are generated from the scan data of the same document by adding, to both the data A and the data B, the attribute information with which the data (the scan data of the document) serving as the data generation source can be identified, the task A and the task B do not need to be in a relationship of forming a multitask. In other words, multitasking is one of ways for associating the task A and the task B in that they have a relationship in which data is generated from the same document.

In the above description, the page data forming the data A is reused to regenerate the data B. However, although the data format can be converted from the first format to the second format, for example, in a case where the data A is a monochrome image and the data B is a color image, since color information is missing from the data A, the page data to be included in the data B cannot be generated even when the data A is subjected to data conversion.

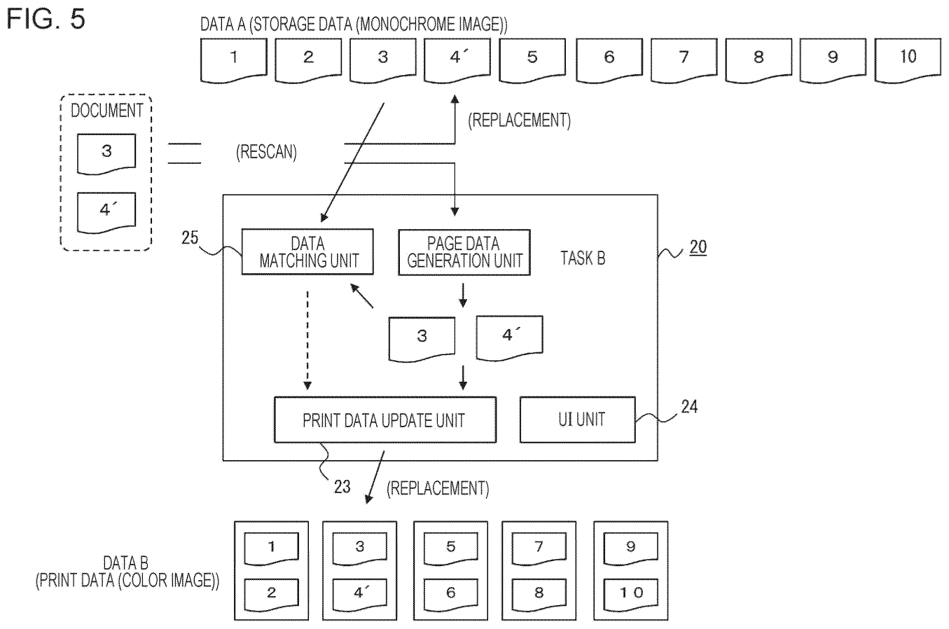

FIG. 5 is, similarly to FIG. 4, a diagram illustrating a block configuration of a function implemented by executing the task B when replacing a part of pages of the document, but is a configuration diagram assuming a case where, as described above, the page data to be included in the data B cannot be generated even when the data A is subjected to data conversion. The task B illustrated in FIG. 5 includes a data matching unit 25 instead of the data conversion unit 22. The same components as those in FIG. 4 are denoted by the same reference numerals, and a description thereof will be omitted.

The flowchart illustrated in FIG. 3 is also applicable to a case where the data A cannot be included in the data B even when the data A is subjected to data conversion. In FIG. 3, in a case where the data A is a monochrome image and the data B is a color image, since reusable page data is not included in the data A (N in Step S104), the task B acquires the third page of the rescanned document (Step S107).

Thereafter, the processing of regenerating the data B by the print data update unit 23 and printing the data B may be similar to that described above (Steps S108 to S114). For example, immediately after Step S107, the data matching unit 25 extracts and acquires the page data of the third page of the document from the data A. In addition, the data matching unit 25 converts the third page of the document obtained by rescanning into a monochrome image. Then, the data matching unit 25 matches the monochrome image acquired from the data A against the monochrome image generated by conversion. Thus, it can be verified that the page of the document rescanned by the user is the third page. The data matching unit 25 notifies the print data update unit 23 of the matching result. The print data update unit 23 receives the notification from the data matching unit 25. When the print data update unit 23 recognizes that the third page is not correct, the print data update unit 23 causes the user to rescan the correct third page by, for example, displaying a message on the operation panel 15.

As described above, the task B can reuse the monochrome image data of the third page extracted and acquired from the data A as the data for determining the validity of the data B to be regenerated, in a more limited way, the validity of the page data of the third page of the document.

According to the present exemplary embodiment, the page data included in the data A generated for storage is reused to regenerate the data B generated for printing. In the processing for replacing a page described with reference to FIG. 4, since the data A and the data B have different data formats, the task B realizes the reuse in which the page data extracted and acquired from the data A is converted and then included in the data B. In FIG. 5, the page data of the data A, which is a monochrome image, cannot be converted into a color image, but is used not for the purpose of storage but for the purpose of determining the validity that the page of the rescanned document is the third page, and therefore, this case also corresponds to reuse in terms of use for purposes other than the original purpose.

Here, the relation between the data attributes of the data A and the data B has been described using the color attribute of the image as an example, but there is no need to be limited thereto. For example, even in a case where the resolution of the data A is lower than that of the data B, although the data A cannot be included in the data B simply by converting the format of page data of the data A, the data A can be reused to determine the validity in a similar manner to the case of the color attribute of the image.

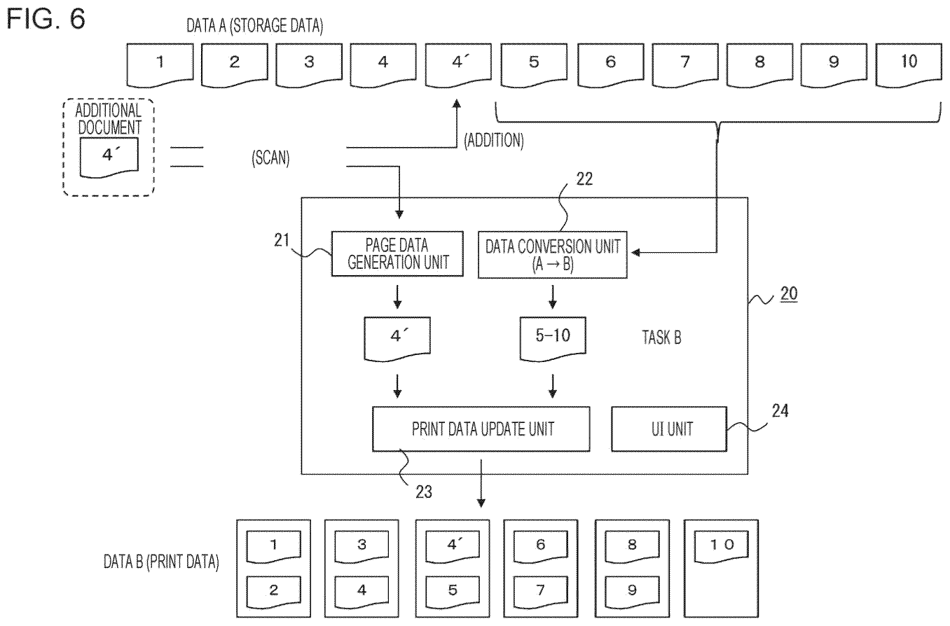

Subsequently, as a case of changing the page layout of the document, the case of adding a page to the document will be described with reference to FIG. 6.

FIG. 6 is a diagram illustrating a block configuration of a function performed by executing the task B when a page is added to the document according to the present exemplary embodiment. The function of the task B needed for adding a page to the document may be the same as that in the case of replacement. In FIG. 6, a case in which a page 4′ is added between the fourth page and the fifth page of the document will be described as an example.

The flowchart illustrated in FIG. 3 can also be applied to a case where a page is added to the document, and thus the same processing as in the case of replacement is omitted as appropriate. When a page is added immediately after the fourth page, the data B requires the page data of the fifth to tenth pages because the pairs of page data are shifted as illustrated in FIG. 6. Therefore, the task B acquires the page data corresponding to the fifth to tenth pages from the data A (Step S105). Then, the data conversion unit 22 converts the page data of the fifth to tenth pages acquired from the task A into the page data in the second format (Step S106). Furthermore, when acquiring the scan data of 4′ to be added, the page data generation unit 21 generates the page data of 4′ in the second format from the scan data (Step S109).

As described above, when the page data of the fifth to tenth pages of the document arranged after the additional page data is extracted and acquired from the data A in addition to the page data (hereinafter also referred to as “additional page data”) of the page 4′ to be added, the print data update unit 23 generates the print page data corresponding to the third to sixth pages in the data B with the page data after the additional page data. Then, the print data update unit 23 acquires the data B and updates the print data (i.e., the data B) by replacing the print page data of the third and subsequent pages in the acquired data B with the generated print page data (Step S112). The subsequent processing in the task B has been already described, and hence description thereof is omitted.

In the related art, it is necessary to also scan the document of the fifth to tenth pages after the position where the page is added in the data B together with the added page, but according to the present exemplary embodiment, it is sufficient to scan only the page to be added.

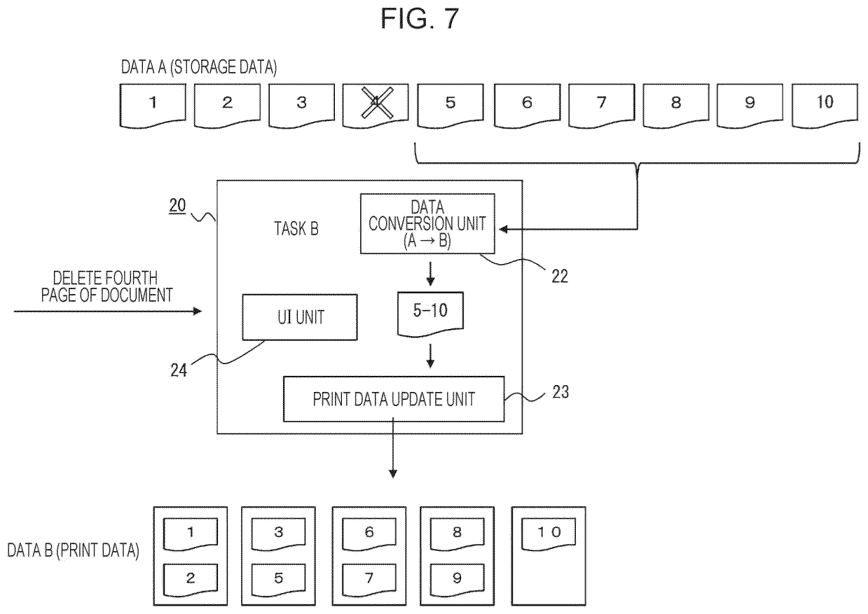

Finally, as a case where the page layout of the document is changed, a case where a page is deleted from the document will be described with reference to FIG. 7.

FIG. 7 is a diagram illustrating a block configuration of a function performed by executing the task B when a page is deleted from the document according to the present exemplary embodiment. In the case of deleting a page from the document, there is no new page of the document to be read, and therefore, the page data generation unit 21 is unnecessary.

For example, the user designates the fourth page of the document as the page to be deleted by operating the operation panel 15 or the like. When the user interface unit 24 receives the instruction (Y in Step S102), the task B acquires, from the data A, the pages arranged after the position of the fourth page to be deleted, that is, the page data corresponding to the fifth to tenth pages, in the data B to be regenerated (Step S105). Then, the data conversion unit 22 converts the page data of the fifth to tenth pages acquired from the task A into the page data in the second format (Step S106).

When the page is to be deleted from the document (Y in Step S108), the print data update unit 23 deletes the page data of the unnecessary fourth page from the existing data B, then combines the page data of the third page, which has been paired with the fourth page to be deleted, and the page data of the fifth page, and also rearranges the page data of the sixth to tenth pages to be combined, thereby updating the data B as illustrated in FIG. 7 (Step S112).

In the related art, it is necessary to scan the document of the third page and the fifth to tenth pages in which the pair to be combined is changed by deleting the fourth page in the data B, but it is not necessary to scan the pages of the document according to the present exemplary embodiment.

As described above, as the case of changing the page layout of the document, the replacement of the pages forming the document, the addition of the page, and the deletion of the page have been described as examples with separate drawings prepared for each, but these layouts may be combined as appropriate.

In addition, replacement, deletion, or page addition position is set to the fourth page alone, but may be a different position or a plurality of pages.

The “information processing system” according to the present exemplary embodiment is described as being configured by the single multifunction peripheral 10 as an example, but may be configured by a plurality of information processing apparatuses. Furthermore, instead of the multifunction peripheral 10 which is one form of an image forming apparatus, an information processing apparatus such as a PC, which can be connected to a network, may be used for implementation. When a PC is used for implementation, the PC may be connected to a scanner or may be configured to acquire scan data via a network from the multifunction peripheral 10, or the like, equipped with a scanner.

According to the above exemplary embodiment, the processor refers to a processor in a broad sense and includes general-purpose processors (for example, a central processing unit (CPU)) and dedicated processors (for example, a graphics processing unit (GPU), Application Specific Integrated Circuit (ASIC), Field Programmable Gate Array (FPGA), and programmable logic devices).

Further, the operation of the processor according to the above-described exemplary embodiment may be performed not only by one processor but also by a plurality of processors existing at physically distant positions in cooperation with each other. Furthermore, the order of each operation of the processor is not limited to the order described in the above-described exemplary embodiment and may be appropriately changed.

### Appendix

(((1)))

An information processing system comprising: a processor configured to:
acquire document image data in a first format and document image data in a second format different from the first format, generated from a document including a plurality of pages;
when the document image data in the first format includes reusable image data of the page of the document to regenerate the document image data in the second format in response to a change in a layout of the page of the document, extract the reusable image data of the page from the document image data in the first format; and regenerate the document image data in the second format by using the extracted image data of the page.
   (((2)))

The information processing system according to (((1))), wherein the processor is configured to convert the image data of the page extracted from the document image data in the first format into image data in the second format, include the image data in the second format in the document image data in the second format, and thus regenerate the document image data in the second format.

(((3)))

The information processing system according to (((2))), wherein when the image data of the page extracted from the document image data in the first format cannot be converted into the image data in the second format, the processor is configured to reuse the extracted image data of the page as data for determining validity of the document image data in the second format to be regenerated.

(((4)))

The information processing system according to any one of (((1))) to (((3))), wherein
page image data corresponding to one page included in the document image data in the first format is generated corresponding to each page forming the document, and
page image data corresponding to one page included in the document image data in the second format is generated by laying out image data of a plurality of pages forming the document.
   (((5)))

The information processing system according to (((4))), wherein
when the change in the layout of the page in the document is page replacement, the processor is configured to acquire, as replacement page data, page data in the second format of the page to be replaced, and
extract, from the document image data in the first format, image data of the page of the document to be included in the same page image data as the replacement page data when the document image data in the second format is regenerated.
   (((6)))

The information processing system according to (((4))), wherein
when the change in the layout of the page in the document is addition of a page to the document, the processor is configured to acquire page data in the second format of the page to be added as additional page data, and
extract, from the document image data in the first format, image data of the page of the document arranged after the additional page data in the document image data in the second format after regeneration as reusable image data of the page of the document when the document image data in the second format is regenerated.
   (((7)))

The information processing system according to (((4))), wherein when the change in the layout of the page in the document is deletion of the page included in the document, the processor is configured to extract, from the document image data in the first format, image data of the page of the document arranged after a position of the image data of the page to be deleted in the document image data in the second format after regeneration as reusable image data of the page of the document when the document image data in the second format is regenerated.

(((8)))

A program causing a computer to execute a process including:
acquiring document image data in a first format and document image data in a second format different from the first format, generated from a document including a plurality of pages;
when the document image data in the first format includes reusable image data of the page of the document to regenerate the document image data in the second format in response to a change in a layout of the page of the document, extracting the reusable image data of the page from the document image data in the first format; and
regenerating the document image data in the second format by using the extracted image data of the page.
   (((9)))

An information processing method causing a computer to execute a process including:
acquiring document image data in a first format and document image data in a second format different from the first format, generated from a document including a plurality of pages;
when the document image data in the first format includes reusable image data of the page of the document to regenerate the document image data in the second format in response to a change in a layout of the page of the document, extracting the reusable image data of the page from the document image data in the first format; and
regenerating the document image data in the second format by using the extracted image data of the page.

What is claimed is:

1. An information processing system comprising:
a processor configured to:
acquire document image data in a first format and document image data in a second format different from the first format, generated from a document including a plurality of pages;
when the document image data in the first format includes reusable image data of the page of the document to regenerate the document image data in the second format in response to a change in a layout of the page of the document, extract the reusable image data of the page from the document image data in the first format; and
regenerate the document image data in the second format by using the extracted image data of the page.

2. The information processing system according to claim 1, wherein the processor is configured to convert the image data of the page extracted from the document image data in the first format into image data in the second format, include the image data in the second format in the document image data in the second format, and thus regenerate the document image data in the second format.

3. The information processing system according to claim 2, wherein when the image data of the page extracted from the document image data in the first format cannot be converted into the image data in the second format, the processor is configured to reuse the extracted image data of the page as data for determining validity of the document image data in the second format to be regenerated.

4. The information processing system according to claim 1, wherein
page image data corresponding to one page included in the document image data in the first format is generated corresponding to each page forming the document, and
page image data corresponding to one page included in the document image data in the second format is generated by laying out image data of a plurality of pages forming the document.

5. The information processing system according to claim 4, wherein
when the change in the layout of the page in the document is page replacement, the processor is configured to: acquire, as replacement page data, page data in the second format of the page to be replaced; and
extract, from the document image data in the first format, image data of the page of the document to be included in the same page image data as the replacement page data when the document image data in the second format is regenerated.

6. The information processing system according to claim 4, wherein
when the change in the layout of the page in the document is addition of a page to the document, the processor is configured to: acquire page data in the second format of the page to be added as additional page data; and
extract, from the document image data in the first format, image data of the page of the document arranged after the additional page data in the document image data in the second format after regeneration as reusable image data of the page of the document when the document image data in the second format is regenerated.

7. The information processing system according to claim 4, wherein when the change in the layout of the page in the document is deletion of the page included in the document, the processor is configured to extract, from the document image data in the first format, image data of the page of the document arranged after a position of the image data of the page to be deleted in the document image data in the second format after regeneration as reusable image data of the page of the document when the document image data in the second format is regenerated.

8. A non-transitory computer readable medium storing a program causing a computer to execute a process comprising:
acquiring document image data in a first format and document image data in a second format different from the first format, generated from a document including a plurality of pages;
when the document image data in the first format includes reusable image data of the page of the document to regenerate the document image data in the second format in response to a change in a layout of the page of the document, extracting the reusable image data of the page from the document image data in the first format; and
regenerating the document image data in the second format by using the extracted image data of the page.

9. An information processing method causing a computer to execute a process comprising:
acquiring document image data in a first format and document image data in a second format different from the first format, generated from a document including a plurality of pages;
when the document image data in the first format includes reusable image data of the page of the document to regenerate the document image data in the second format in response to a change in a layout of the page of the document, extracting the reusable image data of the page from the document image data in the first format; and
regenerating the document image data in the second format by using the extracted image data of the page.
